(19) United States
(12) Patent Application Publication
(10) Pub. No.: US 2022/0295826 A1
(43) Pub. Date: Sep. 22, 2022

(54) PLANT-BASED FOOD PRODUCTS

(71) Applicant: Umaro Foods, Inc., Albany, CA (US)

(72) Inventors: Beth Alison Zotter, Albany, CA (US); Amanda Stiles, Richmond, CA (US)

(21) Appl. No.: 17/702,483

(22) Filed: Mar. 23, 2022

Related U.S. Application Data
(63) Continuation of application No. 17/233,422, filed on Apr. 16, 2021, now abandoned.
Application No. 17/233,422 is a continuation of application No. 17/285,076, filed on Apr. 13, 2021.
(60) Provisional application No. 62/880,636, filed on Jul. 30, 2019.

(51) Int. Cl. A23J 3/22; A23L 17/60; A23J 3/14; A23J 1/00; A23L 33/185

(52) U.S. Cl. CPC A23J 3/227; A23L 17/60; A23J 3/14; A23J 1/006; A23L 33/185; A23V 2002/00

(57) ABSTRACT

The present invention relates to the use of a seaweed based food product that provides the color, texture and nutrients necessary to prepare a meat-like product that is capable of providing the consistency, texture and taste of a meat that is commonly consumed, including from animals such as a cow, a sheep, a pig, a chicken, a turkey, an ostrich and a fish. The seaweed-based food product can be derived from a red, brown or green seaweed that is capable of providing the taste, consistency and color, both when cooked and when raw, of a meat that is consumed.

### BACKGROUND

Currently there are several alternative plant-based food products resembling meat (hereinafter “meat-like food products”) available to consumers. These are prepared from plant-based analogues to meat, egg and dairy products that are created to employ a variety of ingredients to replicate the taste, texture, and appearance of those animal food products. There are several challenges to creating a plant-based food product that provides the same texture, taste and color of animal meat. These include the reduced protein content found in plants when compared to such animal products as meat, cheese, eggs, and milk, which are all high in protein content. They also include the problem that many meat-like food products do not start with the color of actual meat when raw and/or do not maintain the color of animal meat after being cooked.

Many meats from animals are reddish-pink in color. These include beef, tuna and pork. In contrast, protein concentrates from grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans, corn and wheat range from yellow to white. Vegetable dyes can be added to recreate the color of meat. This is important as acceptance of a meat-like product in place of actual meat from an animal will require that the meat-like product taste and feel like actual meat and that it will look like actual meat after being cooked, including a brownish color on the outside and a pinkish to reddish color on the inside. Currently, many of the meat-like food products derived or obtained from plants include vegetable dyes that often do not change color, with the result that the outside and inside of the meat-like food product remains pinkish to red in color even after cooking. In these instance, it is not unusual for the company selling the meat-like food product to include on its label a warning not to overcook it based on a concern that the person cooking the meat-like product will overcook it due to a lack of the expected color change.

Another problem associated with meat-like food products is that they do not replicate the texture of animal meat products. For instance, meat-like food product generally does not provide the adhesion forces of proteins to each other that is necessary to emulate the texture of animal meat. Currently, to overcome this issue, manufacturers attempt to achieve the adhesion of animal meat by a number of mechanical processes. These include extrusion and kneading of the meat-like food product, and by adding gels to increase the meat-like product's tensile strength. Meat-like products also suffer from an issue related to water content and water retention as compared to animal meat. Many meat-like food products are generated from plants that start with lower water content than animal meat. Additionally, many meat-like food products are not able to retain sufficient moisture during the cooking process or when packaged for sale to replicate the juiciness found in actual animal meats. Then there is the issue of taste. For most meat-like food products, seasonings have to be added to mimic the taste of actual meat. These seasonings can include various natural flavors and extracts. Other additives can be included in a meat-like product to mimic the nutritional properties, including, vitamins, amino acids, and minerals can be added.

The present invention intends to overcome shortcomings found in meat-like food products that are derived from grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans, corn and wheat by providing a seaweed extract that has a higher protein content and/or contains natural colorings to make a meat-like food product look, feel and taste more like animal meat.

### SUMMARY OF THE INVENTION

In an aspect of the invention, a plant-based meat-like food product comprising of about 1% to about 90% of a seaweed protein concentrate, about 1% to about 90% of a non-seaweed protein isolate or concentrate, about 0% to about 30% of carbohydrate, and about 1% to 30% lipid. In another aspect of the invention, the plant-based meat-like product is a seaweed protein concentrate containing 35-90% protein. In a further aspect of the invention the protein fraction of the seaweed protein concentrate in the plant-based meat-like food product is at least 25% phycoerythrin. In an aspect of the invention, the plant-based meat-like food product has a seaweed protein concentrate comprising a polyphenol content from about 0.1% to 10%.

In an aspect of the invention, the plant-based meat-like food product contains an animal protein. The animal protein may be derived from animals, cultured animal cells, or produced from recombinant microorganisms.

In another aspect of the invention, the plant-based meat-like food product is derived and/or obtained from a red seaweed (Rhodophyta). In an aspect of the invention, the the red seaweed is Gracilaria, Porphyra, Pyropia, Kappaphycus, Eucheuma, Chondracanthus, Mazzaella, Gigartina, Gelidium, Sarcothalia, Halymenia, and/or Palmaria. In a further aspect of the invention, the plant-based meat-like product is derived from a brown seaweed (Phaeophyta). In an aspect of the invention, the brown seaweed is Undaria, Alaria, Laminaria, Sargassum, Fucus, Lessonia, EckIonia, Durvillaea, Macrocystis, Ascophyllum and/or Saccharina. In another aspect of the invention, the seaweed protein is derived from a green seaweed (Chlorophyta). In an aspect of the invention, the green seaweed is Ulva.

In an aspect of the invention the plant-based meat-like food product is to replace a meat. In a further aspect of the invention, the meat to be replaced is from a cow, a goat, a sheep, a pig or a bird. In an aspect of the invention, the plant-based meat-like food product is to replace a seafood. In an aspect of the invention, the meat to be replaced is from a fish, a shrimp, a lobster, a crab, a scallop, a squid, an octopus or an eel. In an aspect of the invention, the plant-based meat-like food product is to replace a cheese. In an aspect of the invention, the cheese to be replaced is from a cow, a goat or a sheep. In an aspect of the invention, the plant-based meat-like food product is to replace an egg. In an aspect of the invention, the egg to be replaced is from a chicken, a turkey or an ostrich. In an aspect of the invention, the plant-based meat-like food product is to replace milk. In an aspect of the invention, the milk to be replaced is from a cow, a goat or a sheep.

### DETAILED DESCRIPTION

The present invention relates to a plant-based meat-, egg-, or dairy-like food product that combines a plant-based protein, for instance, in an embodiment, a seaweed-based protein concentrate that contributes to the improved taste, texture, and/or color of the resulting food product. The present invention overcomes some of the disadvantages found when using grains (including: quinoa, barley, bulgur; farm and kasha); pulse (including, lentils, dry beans; dry broad beans, dry peas, chickpeas, cow peas, pigeon peas, Bambara beans; vetches, lupins, pulses nes), cereals (including, pearl millet, pros: millet, sorghum, oats, rye, teff; triticale, finger millet; fordo, foxtail millet, kodo millet, Japanese millet, Job's Tears), pseudograins (including, amaranth; breadnut, buckwheat; chia, cockscomb, pitseed goosefoot, kaniwa, wattleseed) legumes (including, alfalfa, clover, peas, beans, lupins, mesquite, carob, soybeans; peanuts, tamarind), rice, mung beans; corn or wheat based protein concentrates to create a plant-based meat, egg, or dairy like product by using, in an embodiment, a seaweed extract, including a seaweed-based protein concentrate, which provides improved taste, texture and/or color.

The term “seaweed-based protein” means a concentrated fraction of protein that is derived from a seaweed.

The seaweed can be a green, brown or red seaweed type. Green types of seaweeds are generally found at the shallowest depths, generally in intertidal zones. A green seaweed includes sea lettuce, gut weed and sea rimu. They can belong to the group Prasinophyta or Charophyte, of which there are five divisions; Mesostigma Phyceae, Klebsormidium Phyceae, Zygnematophyceae, Coleochaetales and Charophyceae.

Brown seaweeds are larger than the green type of seaweed. The largest type of brown seaweed is kelp. Kelp is also high in vitamins A, C, E, D and K. Brown seaweed varies in color from deep olive green to dark brown. Brown seaweeds are found in both the temperate and polar regions.

Red seaweed can vary in size and thickness. Red seaweed can vary in color from a light reddish-pink to an intensely deep reddish-purple. Red seaweed contains sulfated polysaccharides including carrageenan and agar. Agar or carrageenan can be used as a gelling agent, a thickening agent, or a stabilizing agent. There are three main commercial classes of carrageenan: kappa, iota, lambda. Agar is a mixture of agarose and agaropectin. Of the red seaweed variety, Gigartina chamissoi is a leafy seaweed that contains a large spectrum of beneficial polysaccharides known as carrageenans. Gelidium and Gracilaria contain high amounts of agar. Red seaweeds can also contain vitamin B12. Porphyra and Pyropia contain high amounts of B12.

In an embodiment, a protein concentrate is derived and/or obtained from a seaweed. In another embodiment, a seaweed protein concentrate is derived from a red seaweed. A red seaweed can include and/or be selected from the group of Gracilaria, Porphyra, Pyropia, Kappaphycus, Eucheuma, Chondracanthus, Mazzaella, Gigartina, Gelidium, Sarcothalia, Halymenia, and Palmaria.

In another embodiment, a seaweed protein concentrate is derived and/or obtained from a brown seaweed. A brown seaweed can include or be selected from the group of Undaria, Alaria, Laminaria, Sargassum, Fucus, Lessonia, EckIonia, Durvillaea, Macrocystis, Ascophyllum, and Saccharina.

In a further embodiment, a plant based protein concentrate, including a seaweed protein concentrate is derived and/or obtained from plant cells grown through cellular agriculture.

The term “animal meat” as used herein refers to flesh, whole meat muscle, muscle tissue derived from animal cell culture, organs or any parts thereof that are derived from an animal. An animal can include a cow, a sheep, a pig, a goat, a bird, a fish, a shellfish (including a scallop, a clam, an oyster), a crustacean (including a crab, a lobster), a duck, an emu and ostrich, or any other species commonly understood to comprise a source of meat that is used for consumption by another animal, including a human.

The term “meat-like dough” as used herein refers to a blend of ingredients, dry and/or wet, used to make a plant-based meat-like product from either a non-animal source (e.g., proteins, carbohydrates, lipids including liquid oils, heme containing protein or an iron salt, water, and all other ingredients added with water) or from a mixture of a non-animal source and an animal source wherein the one or more of proteins, carbohydrates, lipids, water and all other ingredients added with water from which a plant-based meat-like product is prepared as described herein are produced, derived or obtained from an animal and also a non-animal source.

To create a meat-like dough and then a plant-based meat-like product, the various ingredients are blended using a mechanical force (e.g., spinning, agitating, shaking, shearing, pressure, turbulence, impingement, confluence, beating, friction, wave), a radiation energy (e.g., microwave, electromagnetic), a thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids) or other methods that lead to protein denaturation and protein fiber alignment, or combinations of these methods, followed by fixation of the fibrous structure (e.g., by rapid temperature and/or pressure change, rapid dehydration, chemical fixation, redox).

The term “modified plant source” as used herein refers to a plant that is altered from its native state through some form of modification to create a plant with an enhanced characteristic. The modification can occur through mutation or genetic engineering of the plant nucleotide sequence. The modification can also occur through the creation of hybrids by grafting and other methods.

The term “moisture content” as used herein refer to the amount of moisture in a material as measured, for example by an analytical method and in an embodiment, can be calculated as the percentage change in mass following the evaporation of water from a sample.

The term “natural” or “naturally occurring” as used herein refers to what is found in nature.

The terms “optional” or “optionally” mean that the feature or structure may or may not be present, or that an event or circumstance may or may not occur, and that the description includes instances where a particular feature or structure is present and instances where the particular feature or structure is absent, or instances where the event or circumstance occurs and instances where the event or circumstance does not occur.

The term “pH adjusting agent” as used herein refers to an agent that raises or lowers the pH of a substance, including a solution or a semi-solid, such as a meat-like dough.

The terms “polypeptide,” “peptide” and “protein” are used interchangeably herein to refer to a polymer of amino acid residues. The terms apply to amino acid polymers in which one or more amino acid residue is an artificial chemical mimetic of a corresponding naturally occurring amino acid, as well as to naturally occurring amino acid polymers and non-naturally occurring amino acid polymer. Methods for obtaining (e.g., producing, isolating, purifying, synthesizing, and recombinantly manufacturing) polypeptides are well known to one of ordinary skill in the art.

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, gamma-carboxyglutamate, and O-phosphoserine. Amino acid analogs refer to compounds that have the same basic chemical structure as a naturally occurring amino acid, i.e., a carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally occurring amino acid Amino acid mimetics refers to chemical compounds that have a structure that is different from the general chemical structure of an amino acid, but that functions in a manner similar to a naturally occurring amino acid.

Amino acids may be referred to herein by either their commonly known three letter symbols or by the one-letter symbols recommended by the IUPAC-IUB Biochemical Nomenclature Commission. Nucleotides, likewise, may be referred to by their commonly accepted single-letter codes.

An amino acid and derivatives thereof can include cysteine, cystine, a cysteine sulfoxide, allicin, selenocysteine, methionine, isoleucine, leucine, lysine, phenylalanine, threonine, tryptophan, 5-hydroxytryptophan, valine, arginine, histidine, alanine, asparagine, aspartate, glutamate, glutamine, glycine, proline, serine, tyrosine, ornithine, carnosine, citrulline, carnitine, ornithine, theanine, and taurine.

The present composition encompasses amino acid substitutions in proteins and peptides, which do not generally alter the activity of the proteins or peptides (H. Neurath, R. L. Hill, The Proteins, Academic Press, New York, 1979). In one embodiment, these substitutions are “conservative” amino acid substitutions. The most commonly occurring substitutions are Ala/Ser, Val/Ile, Asp/Glu, Thr/Ser, Ala/Gly, Ala/Thr, Ser/Asn, Ala/Val, Ser/Gly, Ala/Pro, Lys/Arg, Asp/Asn, Leu/Ile, Leu/Val, Ala/Glu and Asp/Gly, in both directions.

As to “conservatively modified variants” of amino acid sequences, one of skill will recognize that individual substitutions, deletions or additions to a nucleic acid, peptide, polypeptide, or protein sequence which alters, adds or deletes a single amino acid or a small percentage of amino acids in the encoded sequence is a “conservatively modified variant” where the alteration results in the substitution of an amino acid with a chemically similar amino acid. Conservative substitution tables providing functionally similar amino acids are well known in the art. Such conservatively modified variants are in addition to and do not exclude polymorphic variants, interspecies homologs, and alleles of the invention.

The following eight groups each contain amino acids that are conservative substitutions for one another: 1) Alanine (A), Glycine (G); 2) Aspartic acid (D), Glutamic acid (E); 3) Asparagine (N), Glutamine (Q); 4) Arginine (R), Lysine (K); 5) Isoleucine (I), Leucine (L), Methionine (M), Valine (V); 6) Phenylalanine (F), Tyrosine (Y), Tryptophan (W); 7) Serine (S), Threonine (T); and 8) Cysteine (C), Methionine (M) (see, e.g., Creighton, Proteins (1984)).

Analogue as used herein denotes a peptide, polypeptide, or protein sequence which differs from a reference peptide, polypeptide, or protein sequence. Such differences may be the addition, deletion, or substitution of amino acids, phosphorylation, sulfation, acrylation, glycosylation, methylation, farnesylation, acetylation, amidation, and the like, the use of non-natural amino acid structures, or other such modifications as known in the art.

An “isolated plant protein” indicates that the plant protein (e.g., a heme-containing protein, wheat gluten, a seaweed protein, dehydrin protein, an albumin, a globulin, conglycinin, glycinin, a zein or a protein from any of grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans, corn, or mixtures thereof) or plant protein fraction (e.g., a 7S fraction) has been separated from other components of the source material (e.g., other animal, plant, fungal, algal, or bacterial proteins), such that the protein or protein fraction is at least 2%, at least 3%, at least 4%, at least 5%, 10%, 20%, 25%, 30%, 35%, 40%, 45%, 50%, 55%, 60%, 65%, 70%, 75%, 80%, 85%, 90%, 95%, or 99% free, by dry weight, of the other components of the source plant or animal material.

As used herein, the term “springiness” refers to a TPA parameter and is calculated by dividing the height of the food product during the second compression by the original compression distance (see Example 6). It is considered to demonstrate the ability of the analyzed product to spring back after compression.

In some embodiments, the uncooked meat-like food products have a springiness of between about 20 and about 60, about 55, about 50, about 45, about 40, about 35, about 30, or about 25; between about 25 and about 60, about 55, about 50, about 45, about 40, about 35, or about 30; between about 30 and about 60, about 55, about 50, about 45, about 40, or about 35; between about 35 and about 60, about 55, about 50, about 45, or about 40; between about 40 and about 60, about 55, about 50, or about 45; between about 45 and about 60, about 55, or about 50; between about 50 and about 60, or about 55; or between about 55 and about 60. In some embodiments, the uncooked meat-like food products have a springiness of about 0.10, about 0.15, about 0.2, about 0.25, about 0.3, about 0.35, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 30, about 40, about 50, about 60, about 70, about 80 about 90 or about 95.

As used herein, the term “cohesiveness” refers to a IPA parameter and is calculated as the area of work during the first compression. It is considered to demonstrate the structural integrity of the analyzed food product (see Example 6).

In some embodiments, the uncooked meat-like food products have a cohesiveness of between about 0.1 and about 0.5, about 0.45, about 0.4, about 0.35, about 0.3, about 0.25, about 0.2, or about 0.15; between about 0.15 and about 0.5, about 0.45, about 0.4, about 0.35, about 0.3, about 0.25, or about 0.2; between about 0.2 and about 0.5, about 0.45, about 0.4, about 0.35, about 0.3, or about 0.25; between about 0.25 and about 0.5, about 0.45, about 0.4, about 0.35, or about 0.3; between about 0.3 and about 0.5, about 0.45, about 0.4, or about 0.35; between about 0.35 and about 0.5, about 0.45, or about 0.4; between about 0.4 and about 0.5, or about 0.45; or between about 0.45 and about 0.5. In some embodiments, the uncooked meat-like food products have a cohesiveness of In some embodiments, the uncooked meat-like food products have a cohesiveness of about 0.10, about 0.15, about 0.2, about 0.25, about 0.3, about 0.35, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 30, about 40, about 50, about 60, about 70, about 80 about 90 or about 95.

As used herein, the term “hardness” refers to a TPA parameter that is calculated as the peak force of the first compression of the sample in the TPA assay (see Example 6). It is considered to demonstrate the force needed to compress a food material during chewing.

In some embodiments, the uncooked meat-like food products have a hardness of between about 1000 g and about 6000 g, about 5500 g, about 5000 g, about 4500 g, about 4000 g, about 3500 g, about 3000 g, about 2500 g, about 2000 g, or about 1500 g; between about 1500 g and about 6000 g, about 5500 g, about 5000 g, about 4500 g, about 4000 g, about 3500 g, about 3000 g, about 2500 g, or about 2000 g; between about 2000 g and about 6000 g, about 5500 g, about 5000 g, about 4500 g, about 4000 g, about 3500 g, about 3000 g, or about 2500 g; between about 2500 g and about 6000 g, about 5500 g, about 5000 g, about 4500 g, about 4000 g, about 3500 g, about 3000 g; between about 3000 g and about 6000 g, about 5500 g, about 5000 g, about 4500 g, about 4000 g, or about 3500 g; between about 3500 g and about 6000 g, about 5500 g, about 5000 g, about 4500 g, or about 4000 g; between about 4000 g and about 6000 g, about 5500 g, about 5000 g, or about 4500 g; between about 4500 g and about 6000 g, about 5500 g, or about 5000 g; between about 5000 g and about 6000 g, or about 5500 g; or between about 5500 g and about 6000 g. In some embodiments, the uncooked meat-like food products have a hardness of about 100, about 110, about 120, about 130, about 140, about 150, about 160, about 170, about 180 about 190, about 200, about 300, about 350, about 389, about 400, about 500, about 600, about 700, about 800, about 900, about 1000, about 1500, about 2000, about 2500, about 3000, about 3500, about 4000, about 4500, about 5000, about 5500, or about 6000.

As used herein, the term “gumminess” refers to a TPA parameter and is calculated by multiplying the values of the previously described parameters of hardness and cohesiveness (see Example, 6).

In some embodiments, the uncooked meat-like food products have a gumminess of between about 300 and about 1000, about 900, about 800, about 700, about 600, about 500, or about 400; between about 400 and about 1000, about 900, about 800, about 700, about 600, or about 500 between about 500 and about 1000, about 900, about 800, about 700, or about 600; between about 600 and about 1000, about 900, about 800, or about 700; between about 700 and about 1000, about 900, or about 800; between about 800 and about 1000, or about 900; or between about 900 and about 1000. In some embodiments, the uncooked meat-like food products have a gumminess of about 10, about 20, about 25, about 29.5, about 30, about 35, about 40, about 50, about 60, about 70, about 80 about 90 or about 95.

As used herein, the term “chewiness” refers to a TPA parameter and is calculated by multiplying the values of the previously described parameters of gumminess and springiness (see Example 6). It is considered to demonstrate the amount of energy needed to chew a food product prior to swallowing.

In some embodiments, the uncooked meat-like food products have a chewiness of between about 100 and about 500, about 450, about 400, about 350, about 300, about 250, about 200, or about 150; between about 150 and about 500, about 450, about 400, about 350, about 300, about 250, or about 200; between about 200 and about 500, about 450, about 400, about 350, about 300, or about 250; between about 250 and about 500, about 450, about 400, about 350, or about 300; between about 300 and about 500, about 450, about 400, or about 350; between about 350 and about 500, about 450, or about 400; between about 400 and about 500, or about 450; or between about 450 and about 500. In some embodiments, the uncooked meat-like food products have a chewiness of about 0.10, about 0.15, about 0.2, about 0.25, about 0.3, about 0.35, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 30, about 40, about 50, about 60, about 70, about 80 about 90 or about 95.

As used herein, the term “resilience” refers to a TPA parameter and is calculated by dividing the upstroke energy of the first compression by the downstroke energy of the first compression (see Example 6). It is considered to demonstrate the ability of the food product to return to its initial shape.

In some embodiments, the uncooked meat-like food products have a resilience of between about 4 and about 9, about 8.5, about 8, about 7.5, about 7, about 6.5, about 6, about 5.5, about 5, or about 4.5; between about 4.5 and about 9, about 8.5, about 8, about 7.5, about 7, about 6.5, about 6, about 5.5, or about 5; between about 5 and about 9, about 8.5, about 8, about 7.5, about 7, about 6.5, about 6, or about 5.5; between about 5.5 and about 9, about 8.5, about 8, about 7.5, about 7, about 6.5, or about 6; between about 6 and about 9, about 8.5, about 8, about 7.5, about 7, or about 6.5; between about 6.5 and about 9, about 8.5, about 8, about 7.5, or about 7; between about 7 and about 9, about 8.5, about 8, or about 7.5; between about 7.5 and about 9, about 8.5, or about 8; between about 8 and about 9, or about 8.5; or between about 8.5 and about 9. Ire some embodiments, the uncooked meat-like food products have a resilience of about 0.01, about 0.02, about 0.026, about 0.03, about 0.04, about 0.041, about 0.05, about 0.06, about 0.07, about 0.08, about 0.09, about 0.10, about 0.15, about 0.2, about 0.25, about 0.3, about 0.35, about 0.4, about 0.5, about 0.6, about 0.7, about 0.8, about 0.9, about 1, about 2, about 3, about 4, about 5, about 6, about 7, about 8, about 9, about 10, about 11 about 12, about 13, about 14, about 15, about 16, about 17, about 18, about 19, about 20, about 30, about 40, about 50, about 60, about 70, about 30 about 90 or about 95

In some embodiments, the plant-based meat-like product can be formulated with a meat-like dough and other components, including a pH adjusting agent, a binding agent, an antioxidant, a flavoring agent, a carbohydrate and/or a fat. In one embodiment, a plant-based meat-like product is gluten free. In such an embodiment, a blend of maize starch, tapioca flour, rice flour, and guar gum can be used instead of the wheat gluten in the meat-like dough.

The present invention provides a meat-like dough that contains a seaweed protein concentrate from a natural or modified seaweed and at least one other ingredient. In an embodiment, the other ingredient is a protein (natural and/or modified), a carbohydrate, and a lipid (natural or modified form). The addition of a seaweed protein concentrate can provide an improvement in the similarity of a plant-based meat-like dough and/or an egg- or dairy-like product to look, feel and taste like a natural animal food product, such as a hamburger, a hot dog, a sausage, a steak, a chicken breast, a turkey breast or other product created from a natural animal food product. In an embodiment, a seaweed protein concentrate includes a concentrate that is derived from one of the three families of seaweed: either a red, a brown, and/or a green (e.g., Rhodophyta, Phaeophyta, and Chlorophyta). In an embodiment, a protein fraction is enriched from the red, brown and/or green seaweed to create a meat-like dough that includes a seaweed protein fraction.

In one embodiment of the present invention, a meat-like dough is provided that appears pink in color without the addition of vegetable dyes. In an embodiment this meat-like dough that is pink in color without the addition of vegetable dyes is prepared from a red seaweed. In an embodiment this meat-like dough that is pink in color without the addition of vegetable dyes is prepared from a brown seaweed. In an embodiment, a meat-like dough and/or a plant-based meat-like product, includes a coloring agent, such that when it is cooked, it takes on a brownish color on the outside and a pinkish to reddish or reddish-purple color on the inside. In a further embodiment, when the meat-like dough and/or plant-based meat-like product is cooked, it takes on a brownish color on the outside and throughout most if not all of the meat-like dough and/or plant-based meat-like product. In another embodiment of the present invention, a food product is provided where the gel and/or tensile strength of the meat-like dough is increased by the addition of a seaweed protein concentrate. In another embodiment of the present invention, a meat-like dough is provided where the taste of a food product is enhanced by the addition of a seaweed protein concentrate. In a further embodiment of the present invention, a meat-like dough is provided where the fat-binding capacity of the meat-like dough is enhanced by the addition of a seaweed protein concentrate. In another embodiment of the present invention, the addition of a seaweed protein concentrate contributes to a combination of improved attributes among the aspects of color, color change, flavor, gel strength, solubility, fat-binding capacity, and/or nutrition of a meat-like dough.

In an embodiment of the present invention, a meat-like dough is provided where a protein derived and/or obtained from a seaweed that is used in a meat-like dough is either pink, red or reddish-purple in color. In another embodiment, a meat-like dough is provided that reduces or eliminates the need for a gelling ingredient in the meat-like dough. A gelling ingredient can be any gelling or binding agent, such as a carbohydrate. In a further embodiment of the present invention, a meat-like dough is provided where a seaweed protein concentrate increases the fat-binding capacity of the meat-like dough.

In an embodiment, a seaweed protein concentrate increases the fat-binding capacity of a meat-like dough by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100%.

In an embodiment, a seaweed protein concentrate increases the fat-binding capacity of a meat-like dough by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100%.

In an embodiment, a seaweed protein concentrate increases the fat-binding capacity of a meat-like dough by no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100%.

In an embodiment of the present invention, a meat-like dough is provided where the seaweed protein concentrate increases the vitamin B12 content of the meat-like dough. In a further embodiment, the vitamin B12 content of a meat-like dough is increased by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100%.

In a further embodiment, the vitamin B12 content of a meat-like dough is increased by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100%.

In a further embodiment, the vitamin B12 content of a meat-like dough is increased by no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100%.

In a further embodiment, a meat-like dough is provided where the seaweed protein concentrate creates improved functional properties of the protein fraction after extrusion. In another embodiment, the improved functional properties of the protein fraction after extrusion is an improvement in the binding of proteins. In an embodiment, the binding of proteins is improved by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100%.

In an embodiment, the binding of proteins is improved by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100%.

In an embodiment, the binding of proteins is improved by no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100%.

In another embodiment, the addition of a seaweed protein concentrate improves one or more aspect of a meat-like dough. In a further embodiment, the aspect of a meat-like dough that is improved is the meat-like dough's color, flavor, gel strength, solubility, fat-binding capacity, or nutrition. In an embodiment, the improvement in an aspect of a meat-like dough increases the meat-like dough's similarity to natural animal meat food product. In another embodiment, the improvement in an aspect of a meat-like dough increases the meat-like dough's similarity to natural animal meat food product by at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100%.

In another embodiment, the improvement in an aspect of a meat-like dough increases the meat-like dough's similarity to natural animal meat food product by about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100%.

In another embodiment, the improvement in an aspect of a meat-like dough increases the meat-like dough's similarity to natural animal meat food product by no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100%.

In an embodiment, a seaweed protein can be extracted from a seaweed, whether from a red, green or brown using an enzyme. In another embodiment a seaweed protein can be extracted from a seaweed, whether from a red, green or brown by making the pH during the extraction procedure more alkaline with a pH adjusting agent. In an embodiment, a protein concentrate can be made from a seaweed, including a red; green or brown seaweed. In a further embodiment; the protein concentrate from a seaweed is used to prepare a meat-like dough. In another embodiment, the protein concentrate from a seaweed is mixed with a protein concentrate from one or more of a protein concentrate from wheat grains (including, quinoa, barley, bulgur, farro and kasha), pulse (including, lentils, dry beans, dry broad beans, dry peas, chickpeas, cow peas, pigeon peas, Bambara beans, vetches, lupins; pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans, corn or an animal. In one embodiment, the mixed protein concentrate from a seaweed and from one or more of wheat, pea soy or an animal is used to prepare a meat-like dough.

In an embodiment, the meat-like dough provided herein comprises about 5% by weight of protein. In a further embodiment, the meat-like dough provided herein comprise at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% weight by protein of the meat-like dough.

In a further embodiment, the meat-like dough provided herein comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% weight by protein of the meat-like dough.

In a further embodiment, the meat-like dough provided herein comprise no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% weight by protein of the meat-like dough.

In an embodiment, a protein-based meat-like product is comprised of a meat-like dough that is comprised of 1% to 90%, 0.1% to 1%, 0.2% to 1%, 0.3% to 1%. 0.4% to 1%, 0.5% to 1%, 0.6% to 1%, 0.7% to 1%, 0.8% to 1%, 0.9% to 1%, 0.1% to 2, 0.5% to 2.5%, 1% to 5%, 2% to 25%, 3% to 20%, 5% to 50%, 4% to 40%, 3% to 10%, 1% to 3%, 0.1% to 2% or any other combination of concentrations between about 1% to about 90% of a seaweed protein concentrate, about 1% to about 90% of a non-seaweed protein isolate or concentrate, about 0% to about 30% of carbohydrate, and about 1% to 30% lipid.

In an embodiment, a plant-based meat-like product is comprised of a meat-like dough that is comprised of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% seaweed protein concentrate.

In an embodiment, a plant-based meat-like product is comprised of a meat-like down that is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% seaweed protein concentrate.

In an embodiment, a plant-based meat-like product is comprised of a meat-like dough that is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% seaweed protein concentrate.

In an embodiment, a plant-based meat-like product is comprised of a meat-like dough that is comprised of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% of a non-seaweed plant protein concentrate.

In an embodiment, a plant-based meat-like product is comprised of a meat-like dough that is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% of a non-seaweed plant protein concentrate.

In an embodiment, a plant-based meat-like product is comprised of a meat-like dough that is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% of a non-seaweed plant protein concentrate.

In an embodiment, the protein may be comprised of polypeptide molecules having an identical amino acid sequence, or of a mixture of polypeptide molecules having at least 2 different amino acid sequences. In a further embodiment, the protein may be comprised of naturally occurring amino acids or non-naturally occurring amino acids. In a further embodiment, the protein concentrate used to create the meat-like dough can be derived and/or obtained from one type of seaweed or from two or more types of seaweed. In another embodiment, the protein concentrate used to create the meat-like dough can be derived and/or obtained from a seaweed and a one or more other plant sources, including wheat, soy and pea. In another embodiment, the protein concentrate used to create the meat-like dough can be derived and/or obtained from a seaweed and a protein concentrate source wherein the protein is manufactured synthetically using natural or non-natural amino acids. In some embodiments, the protein concentrate used to create the meat-like dough can be derived and/or obtained from a seaweed and an animal source, including a cow, a sheep, a goat, a pig, a duck, an ostrich or an emu. In another embodiment, the protein concentrate used to create the meat-like dough can be derived and/or obtained from a seaweed and an animal source, including a fish, a shellfish, or a crustacean. In some embodiments, the protein is not derived from a plant source but is identical or similar to protein found in a plant source, for example, the protein is synthetically or biosynthetically generated but comprises polypeptide molecules that have an identical or similar amino acid sequence as polypeptide molecules found in an animal source.

In an embodiment, the ratio of protein concentrate derived and/or obtained from a seaweed versus derived and/or obtained from a non-seaweed source (e.g. other plant, synthetically produced or animal) is 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:87, 44:56, 45:55, 46:54, 47:53, 48:52, 49:51, 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71, 29, 72:28, 73:27, 74:26, 75:25, 76:24, 77:23, 78:22, 79:21, 80:20, 81:19, 82:18, 83:17, 84:16, 85:15, 84:16, 85:15, 86:14, 87:13, 88:12, 89:11, 90:10, 91:9, 92:8, 93:7, 94:6, 95:5, 96:4, 97:3, 98:2 or 99:1.

In some embodiments, the meat-like dough contains a protein concentrate that is between about 10% and about 90%, between about 20% and about 80%, between about 30% and about 70%, between about 34% and about 50%, between about 30% and about 60%, between about 30% and about 50%, between about 40% and about 50%, between about 60% and about 80%, or between about 70% and about 90% of the weight of the meat-like dough. In some embodiments, the meat-like dough comprises between about 5% and about 45%, between about 10% and about 40%, between about 10% and about 25%, between about 15% and about 35%, between about 15% and about 30%, between about 15% and about 25%, between about 10% and about 25%, between about 20% and about 25%, between about 30% and about 40%, between about 35% and about 45%, between about 5% and about 65%, between about 10% and about 60%, or between about 15% and about 55% by weight of protein.

Protein content of a food product can be determined by a variety of methods, including but not limited to AOAC International reference methods AOAC 990.03 and AOAC 992.15. In some embodiments, the meat-like dough comprises seaweed protein. In an embodiment, the meat-like dough comprises a green, red and/or brown seaweed protein. In a further embodiment, the seaweed protein may be derived and/or obtained from the whole seaweed plant or from a component of a seaweed plant in accordance with methods generally known in the art. In another embodiment, the seaweed may be naturally occurring seaweed (e.g., non-modified seaweed), a modified seaweed (including through genetic engineering or grafting), a commonly commercially available seaweed or combinations thereof. In an embodiment, a plant protein may be derived and/or obtained from the whole plant or from a component of a plant in accordance with methods generally known in the art. In another embodiment, the plant may be naturally occurring (e.g., a non-modified plant), a modified plant (including through genetic engineering or grafting), a commonly commercially available plant such as wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fordo, foxtail millet, kodo Japanese millet, Job's Tears), pseudograins (including, amaranth, breadnut, buckwheat, chia, cockscomb, pitseed goosefoot, kaniwa, wattleseed) legumes (including, alfalfa, clever, peas, beans, lupins, mesquite, carob, soybeans, peanuts, tamarind), rice, mung beans, corn or wheat or combinations thereof.

In a further embodiment of the invention the plant-based meat-like product is comprised of a meat-like dough that comprises a protein fraction of the seaweed protein concentrate is at least 25% phycoerythrin. In another embodiment, the seaweed protein concentrate is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% phycoerythrin. A phycoerythrin can be a B-phycoerythrin (B-PE), a R-phycoerythrin (R-PE) and/or a C-phycoerythrin.

In another embodiment, the seaweed protein concentrate is comprised of about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% phycoerythrin.

In another embodiment, the seaweed protein concentrate is comprised of no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% phycoerythrin.

In another embodiment, the plant-based meat-like product is comprised of a meat-like dough that has a polyphenol content is from about 1% to 10%. In a further embodiment, the plant-based meat-like product has a polyphenol content of at least 0.1%, at least 0.2%, at least 0.3%, at least 0.4%, at least 0.5%, at least 0.6%, at least 0.7%, at least 0.8%, at least 0.9%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%. In another embodiment, the plant-based meat-like product is comprised of a meat-like dough that has a polyphenol content is about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%. In another embodiment, the plant-based meat-like product is comprised of a meat-like dough that has a polyphenol content is no more than 0.1%, no more than 0.2%, no more than 0.3%, no more than 0.4%, no more than 0.5%, no more than 0.6%, no more than 0.7%, no more than 0.8%, no more than 0.9%, no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%

In an embodiment, the plant-based meat-like product is comprised of a meat-like dough that contains an animal protein. In another embodiment, the animal protein is from a cow, a pig, a goat, a sheep, a horse, a bird, a fish, an ostrich or an emu.

In another embodiment, the plant-based meat-like product is comprised of a meat-like dough that is derived and/or obtained from a red seaweed (Rhodophyta). In an embodiment, the red seaweed is Gracilaria, Porphyra, Pyropia, Kappaphycus, Eucheuma, Chondracanthus, Mazzaella, Gigartina, Gelidium, Sarcothalia, Halymenia, or Palmaria. In a further embodiment, the plant-based meat-like product is derived from a brown seaweed (Phaeophyta). In another embodiment, the brown seaweed is Undaria, Alaria, Laminaria, Sargassum, Fucus, Lessonia, EckIonia, Durvillaea, Macrocystis, Ascophyllum, or Saccharina. In another embodiment, the seaweed protein is derived from a green seaweed (Chlorophyta). In a further embodiment, the green seaweed is Ulva.

In an embodiment, the plant-based meat-like product is to replace a meat from an animal. In a further embodiment, the meat to be replaced is from a cow, a goat, a sheep, a pig or a bird. In an embodiment, the plant-based meat-like product is to replace a seafood. In an embodiment, the meat to be replaced is from a fish, a shrimp, a lobster, a crab, a squid, an octopus or an eel. In an embodiment, the plant-based meat-like product is to replace a cheese. In an embodiment, the cheese to be replaced is from a cow, a goat or a sheep. In an embodiment, the plant-based meat-like product is to replace an egg. In an embodiment, the plant-based meat-like product the egg to be replaced is from a chicken, a turkey or an ostrich. In an embodiment, the plant-based meat-like product is to replace milk. In an embodiment, the milk to be replaced is from a cow, a goat or a sheep.

In some embodiments, the meat-like dough provided herein comprises between about 10% and about 90%, between about 20% and about 80%, between about 30% and about 70%, between about 40% and about 60% or between about 34% and about 46% by weight of Carrageenan. In some embodiments, the protein concentrate provided herein comprises between about 5% and about 45%, between about 10% and about 40%, between about 15% and about 35%, between about 10% and about 25%, between about 20% and about 30%, between about 10% and about 90%, between about 15% and about 85%, between about 20% and about 70%, between about 25% and about 65%, between about 30% and about 60%, between about 35% and about 55% or between about 40% and about 50% by weight of Carrageenan.

In some embodiments, the meat-like dough provided herein comprises between about 10% and about 90%, between about 20% and about 80%, between about 30% and about 70%, between about 40% and about 60% or between about 34% and about 46% by weight of Agar. In some embodiments, the protein concentrate provided herein comprises between about 5% and about 45%, between about 10% and about 40%, between about 15% and about 35%, between about 10% and about 25%, between about 20% and about 30%, between about 10% and about 90%, between about 15% and about 85%, between about 20% and about 70%, between about 25% and about 65%, between about 30% and about 60%, between about 35% and about 55% or between about 40% and about 50% by weight of Agar.

Agar, which can consist of two polysaccharides, agarose and agaropectin, is also known as Agar-Agar, Kanten, Japanese Isinglass, Ceylon moss or Jaffna moss can come from a red algae, including Gigartina or Gracilaria. In an embodiment, agarose makes up about 10%, about 20%, about 30%, about 40%, about 50%, about 60%, about 70 or 75% of the agar.

In some embodiments, the meat-like dough provided herein comprises between about 10% and about 90%, between about 20% and about 80%, between about 30% and about 70%, between about 40% and about 60% or between about 34% and about 46% by weight of Porphyran. In some embodiments, the protein concentrate provided herein comprises between about 5% and about 45%, between about 10% and about 40%, between about 15% and about 35%, between about 10% and about 25%, between about 20% and about 30%, between about 10% and about 90%, between about 15% and about 85%, between about 20% and about 70%, between about 25% and about 65%, between about 30% and about 60%, between about 35% and about 55% or between about 40% and about 50% by weight of Porphyran.

In some embodiments, the meat-like dough provided herein comprises between about 10% and about 90%, between about 20% and about 80%, between about 30% and about 70%, between about 40% and about 60% or between about 34% and about 46% by weight of Alginate. In some embodiments, the protein concentrate provided herein comprises between about 5% and about 45%, between about 10% and about 40%, between about 15% and about 35%, between about 10% and about 25%, between about 20% and about 30%, between about 10% and about 90%, between about 15% and about 85%, between about 20% and about 70%, between about 25% and about 65%, between about 30% and about 60%, between about 35% and about 55% or between about 40% and about 50% by weight of Alginate.

In some embodiments, the meat-like dough provided herein comprises between about 10% and about 90%, between about 20% and about 80%, between about 30% and about 70%, between about 40% and about 60% or between about 34% and about 46% by weight of Fucoidan. In some embodiments, the protein concentrate provided herein comprises between about 1% and about 10%, between about 5% and about 15%, between about 10% and about 20%, between about 15% and about 25%, between about 20% and about 30%, between about 10% and about 90%, between about 15% and about 85%, between about 20% and about 70%, between about 25% and about 65%, between about 30% and about 60%, between about 35% and about 55% or between about 40% and about 50% by weight of Fucoidan

In a further embodiment, a plant-based meat-like product is comprised of a meat-like dough and one or more of a fat, a carbohydrate, including a carbohydrate gel, a flavoring agent and/or a heme containing protein or an iron salt.

In an embodiment, a plant-based meat-like product can include a carbohydrate. A variety of ingredients may be used as all or part of a carbohydrate, including but not limited to starch, flour, edible fiber, and combinations thereof. Examples of suitable starches include but are not limited to maltodextrin, inulin, fructo oligosaccharides, pectin, carboxymethyl cellulose, guar gum, corn starch, oat starch, potato starch, rice starch, pea starch, seaweed starch and wheat starch. In an embodiment a carbohydrate is a sugar, sugar alcohol, sugar acid and/or sugar derivative can include glucose, fructose, ribose, sucrose, arabinose, glucose-6-phosphate, fructose-6-phosphate, fructose 1,6-diphosphate, inositol, maltose, mannose, glycerol, molasses, maltodextrin, glycogen, galactose, lactose, ribitol, gluconic acid, glucuronic acid, amylose, amylopectin, or xylose.

Examples of suitable flour include amaranth flour, oat flour, quinoa flour, rice flour, rye flour, sorghum flour, soy flour, wheat flour, seaweed flour and corn flour. Examples of suitable edible fiber include but are not limited to barley bran, seaweed fiber, carrot fiber, citrus fiber, corn bran, soluble dietary fiber, insoluble dietary fiber, oat bran, pea fiber, rice bran, head husks, soy fiber, soy polysaccharide, wheat bran, and wood pulp cellulose. In some embodiments, some of a carbohydrate is derived from plant. The carbohydrate may be derived from any one plant source or from multiple plant sources. In some embodiments, a carbohydrate is not derived from a plant source but is identical or similar to carbohydrate found in a plant source, for example, the carbohydrate is synthetically or biosynthetically generated but comprises molecules that have an identical or similar primary structure as molecules found in a plant source.

In an embodiment, a flavoring agent can include one or more flavor precursors, a flavoring, or a flavoring compound. In one embodiment, a flavoring agent can be a combination of a flavoring and one or more flavor precursors. In a further embodiment, a binding agent can include one or more proteins that have been chemically or enzymatically modified to improve their textural and/or flavor properties, or to modify their denaturation and gelling temperatures. In a further embodiment, one or more flavoring agents can be a sugar, a sugar alcohol, a sugar acid, a sugar derivative, an oil, a free fatty acid, an amino acid or derivative thereof, a nucleoside, a nucleotide, a vitamin, an acid, a peptide, a phospholipid, a protein hydrolysate, a yeast extract, or a mixture thereof. For example, the flavor precursor can be selected from the group consisting of glucose, fructose, ribose, arabinose, glucose-6-phosphate, fructose 6-phosphate, fructose 1,6-diphosphate, inositol, maltose, sucrose, maltodextrin, glycogen, nucleotide-bound sugars, molasses, a phospholipid, a lecithin, inosine, inosine monophosphate (IMP), guanosine monophosphate (GMP), pyrazine, adenosine monophosphate (AMP), lactic acid, succinic acid, glycolic acid, thiamine, creatine, pyrophosphate, vegetable oil, algal oil, sunflower oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, an amino acid derivative, urea, pantothenic acid, ornithine, niacin, glycerol, citrulline, taurine, biotin, borage oil, fungal oil, blackcurrant oil, betaine, beta carotene, B-vitamins, N-Acetyl L-cysteine, iron glutamate and a peptone, or mixtures thereof. In another embodiment, the flavoring agent can be selected from the group consisting of a vegetable extract, a fruit extract, an acid, an antioxidant, a carotenoid, a lactone, and/or any combination of flavoring agents.

In another embodiment, a flavoring agent can include a lactone selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, .gamma.-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, 6-tetradecalactone, and dihydro-4-hydroxy-2(3H)-furanone. In some embodiments, the lactones can be 5-ethyl-4-hydroxy-2-methyl-3(2H)-furanone, butyrolactone, gamma-octalactone, and 6-tetradecalactone.

In another embodiment, a flavoring agent can be a juice from a plant, including a vegetable. The juice can be a vegetable puree, a vegetable extract, a fruit juice, a fruit puree, or a fruit extract. In an embodiment, a vegetable juice, vegetable puree, vegetable extract, a fruit juice, a fruit puree, or a fruit extract is a Cucumis juice, puree, or extract from a cucumber or a melon. In an embodiment, the proteins in a vegetable juice, vegetable puree, vegetable extract, fruit juice, fruit puree, or fruit extract are denatured. Denaturation can be done by cooking or otherwise treating a protein prior to its addition to a plant-based meat-like product. In one embodiment, the vegetable juice, vegetable puree, vegetable extract, fruit juice, fruit puree, or fruit extract can be denatured by heating to about 40 degree. C., to about 50 degree. C., to about 60 degree. C., to about 70 degree. C., to about 80 degree. C., to about 90 degree. C., to about 100 degree. C., to about 110 degree. C., to about 120 degree. C. or to about 130.degree. C. prior to addition to the plant-based meat-like product.

In an embodiment, a plant-based meat-like product is made to have a flavor that is close to or replicates meat from an animal by using one or more carotenoids, wherein the carotenoids are selected from the group consisting of (3-carotene, zeaxanthin, lutein, trans-(3-apo-8′-carotenal, lycopene, canthaxanthin, and combinations thereof.

In an embodiment, a flavoring agent can be a mixture used to make a broth that can be made by combining a heme containing protein or iron salt with one or more other flavoring agents and a fat. The broth can be created by heating the mixture to obtain a flavored broth containing one or more flavoring agents. Suitable flavoring agents to be included in a broth include sugars, sugar alcohols, sugar derivatives, free fatty acids, triglycerides, alpha-hydroxy acids, dicarboxylic acids, amino acids and derivatives thereof, nucleosides, nucleotides, vitamins, peptides, phospholipids, lecithin, pyrazine, creatine, pyrophosphate and organic molecules.

In an embodiment, a flavoring agent can include a polar group, including those the group consisting of choline, ethanolamine, serine, phosphate, glycerol-3-phosphate, inositol and inositol phosphates. In another embodiment, flavoring agents can include (e.g., 5′-ribonucleotide salts, glumatic acid salts, glycine salts, guanylic acid salts, hydrolyzed proteins, hydrolyzed vegetable proteins, insomniac acid salts, monosodium glutamate, sodium chloride, galacto-oligosaccharides, sorbitol, animal meat flavor, animal meat oil, artificial flavoring agents, aspartamine, fumarate, garlic flavor, herb flavor, malate, natural flavoring agents, natural smoke extract, natural smoke solution, onion flavor, shiitake extract, spice extract, spice oil, sugars, yeast extract).

In an embodiment, a fat can be a free fatty acid. A free fatty acid can include caprylic acid, capric acid, lauric acid, myristic acid, palmitic acid, palmitoleic acid, stearic acid, oleic acid, linoleic acid, alpha linolenic acid, gamma linolenic acid, arachidic acid, arachidonic acid, behenic acid, eicosapentaenoic acid, petroselinic acid or erucic acid. Triglycerides can include fatty acid esters of caprylic acid, capric acid, lauric acid, myristic acid, palmitic acid, palmitoleic acid, stearic acid, oleic acid, linoleic acid, alpha linolenic acid, gamma linolenic acid, arachidic acid, arachidonic acid, behenic acid, eicosapentaenoic acid, petroselinic acid or erucic acid.

In another embodiment, a fat can be a phospholipid. In some embodiments, a phospholipid can include a plurality of amphipathic molecules comprising fatty acids, glycerol and polar groups. The fatty acids can be selected from a group consisting of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, conjugated oleic acid, or esters of: oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid, or glycerol esters of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid, or triglyceride derivatives of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid.

In a further embodiment, the fat can be a fat extracted, derived and/or obtained from a plant, a non-plant non-animal fat, an animal fat, or a mixture of a fat from a plant, a non-animal and an animal fat. The fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the fat is a seaweed oil. The fat can be mixed with and contain a flavoring agent, a plant-based protein concentrate (e.g. from a seaweed) and/or a carbohydrate.

In an embodiment, a plant-based meat-like product can include an antioxidant.

In an embodiment, the heme containing protein or iron salt can be a porphyrin, porphyrinogen, corrin, corrinoid, chlorin, bacteriochlorophyll, corphin, chlorophyllin, bacteriochlorin, or isobacteriochlorin that is capable of complexing with an iron molecule. In a further embodiment, a heme containing protein can include (e.g., a non-symbiotic hemoglobin, a Hell's gate globin I, a flavohemoprotein, a leghemoglobin, a heme-dependent peroxidase, a cytochrome c peroxidase, or a mammalian myoglobin). In another embodiment, the heme containing protein can be a leghemoglobin from soy, pea, or cowpea.

In another embodiment, a heme containing protein can be from an animal, including a mammal (e.g., cows, goats, sheep, pigs, ox, horse or rabbits), a bird (e.g. chicken, turkey or pheasant), a plant, seaweed, algae, fungi (e.g., yeast or filamentous fungi), ciliates, protozoa or bacteria. In a further embodiment, a heme containing protein can be from a plant, including Nicotiana tabacum, Nicotiana sylvestris (tobacco), Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola); Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). In an embodiment, a heme containing protein is from a fungi including Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. In a further embodiment, a heme containing protein is from a bacteria including Escherichia coli, Bacillus subtilis, Bacillus licheniformis, Bacillus megaterium, Synechocistis sp., Aquifex aeolicus, Methylacidiphilum infernorum, or a thermophilic bacteria such as Thermophilus spp.

In an embodiment, a heme containing, or other proteins can be created using commonly known in the art genetic engineering to create a recombinantly produced protein. It is commonly known in the art that such proteins can be expressed using bacterial cells, insect cells, fungal cells such as yeast, plant cells such as tobacco, soybean, or Arabidopsis, or mammalian cells. An example of a recombinantly produced heme containing protein is leghemoglobin which can be recombinantly produced in E. coli or Pichia pastoris. One of skill would also understand and know that standard polypeptide synthesis techniques (e.g., liquid-phase polypeptide synthesis techniques or solid-phase polypeptide synthesis techniques, in vitro transcription-translation techniques) can be used to produce a recombinant protein, including a heme containing protein.

In an embodiment, an iron salt includes iron gluconate, chloride, oxalate, nitrate, citrate, ascorbate, ferrous sulfate, ferric pyrophosphate, or any other aqueous soluble salt containing iron.

In an embodiment, a binding agent can be a conglycinin protein.

In an embodiment, a binding agent is added to the plant-based meat-like product to achieve a cohesive texture, tensile strength and feel. In one embodiment, a binding agent includes a carob bean gum, cornstarch, dried whole eggs, dried egg whites, gum arabic, konjac flour maltodextrin, potato flakes, tapioca starch, wheat gluten, vegetable gum, carageenan, methylcellulose, and/or xanthan gum. One of skill will recognize that a binding agent can be determined by testing two or more different binding agents to determine which one achieves the desired cohesive texture, tensile strength and feel. In one embodiment, the binding agent is carrageenan and/or methyl cellulose.

In an embodiment, a plant-based meat-like product can include an antioxidant. In an embodiment, an antioxidant includes carotenes, ubiquinone, resveratrol, alpha-tocopherol, lutein, zeaxanthin, “2,4-(tris-3′,5′-bitert-butyl-4′-hydroxybenzyl)-mesitylene (i.e., Ionox 330)”, “2,4,5-trihydroxybutyrophenone”, “2,6-di-tert-butylphenol”, “2,6-di-tert-butyl-4-hydroxymethylphenol (i.e., Ionox 100)”, “3,4-dihydroxybenzoic acid”, 5-methoxy tryptamine, “6-ethoxy 1,2-dihydro-2,2,4-trimethylquinoline”, acetyl gallate, alpha-carotene, alpha-hydroxybenzyl phosphinic acid, alphaketoglutarate, anoxomer, ascorbic acid and its salts, ascorbyl palmitate, ascorbyl stearate, benzyl isothiocyanate, beta naphthoflavone, beta-apo-carotenoic acid, beta-carotene, beta-carotene, butylated hydroxyanisole (BHA), butylated hydroxytoluene (BHT), caffeic acid, canthaxantin, carnosol, carvacrol, catalase, catechins, chlorogenic acid, citric acid and its salts, clove extract, coffee bean extract, di-stearyl thiodipropionate, dilauryl thiodipropionate, dodecyl gallate, edetic acid, ellagic acid, erythorbic acid, esculetin, esculin, ethyl gallate, ethyl maltol, ethylenediaminetetraacetic acid (EDTA), eucalyptus extract, eugenol, ferulic acid, flavanones, flavones, flavonoids, flavonoids, flavonols, fraxetin, fumaric acid, gallic acid, gentian extract, gluconic acid, glycine, gum guaiacum, hesperetin, hydroquinone, hydroxycinammic acid, hydroxyglutaric acid, hydroxytryrosol, hydroxyurea, isflavones, lactic acid and its salts, lecithin, lecithin citrate; R-alpha-lipoic acid, lutein, lycopene, malic acid, maltol, methyl gallate, mono isopropyl citrate, monoglyceride citrate, morin, N-acetylcysteine, N-hydroxysuccinic acid, “N,N′diphenyl-p phenylenediamine (DPPD)”, natural antioxidants, nordihydroguaiaretic acid (NDGA), octyl gallate, oxalic acid, p-coumaric acid, palmityl citrate, phenothiazine, phosphates, phosphatidylcholine, phosphoric acid, phytic acid, phytylubichromel, pimento extract, polyphosphates, propyl gallate, quercetin, retinyl palmitate, rice bran extract, rosemary extract, rosmarinic acid, sage extract, sesamol, silymarin, sinapic acid, sodium erythorbate, stearyl citrate, succinic acid, superoxide dismutase (SOD), synthetic antioxidantss, syringic acid, tartaric acid, taurine, tertiary butyl hydroquinone (TBHO), thiodipropionic acid, thymol, tocopherols, tocotrienols, trans resveratrol, trihydroxy butyrophenone, tryptamine, tyramine, tyrosol, ubiquinone, uric acid, vanillic acid, vitamin K and derivates, wheat germ oil, zeaxanthin.

In a further embodiment, a plant-based meat-like product can include a coloring agent. In one embodiment, a coloring agent includes FD&C (Food Drug & cosmetics) Red Nos. 14 (erythrosine), FD&C Red Nos. 17 (allura red), FD&C Red Nos. 3 (carmosine), FD&C Red Nos. 4 (fast red E), FD&C Red Nos. 40 (allura red AC), FD&C Red Nos. 7 (ponceau 4R), FD&C Red Nos. 9 (amaranth), FD&C Yellow Nos. 13 (quinoline yellow), FD&C Yellow Nos. 5 (tartazine), FD&C Yellow Nos. 6 (sunset yellow), artificial colorants, natural colorants, titanium oxide, annatto, anthocyanins, beet juice, beta-APE 8 carotenal, beta-carotene, black currant, burnt sugar, canthaxanthin, caramel, carmine/carminic acid, cochineal extract, curcumin, lutein, mixed carotenoids, monascus, paprika, red cabbage juice, riboflavin, saffron, titanium dioxide, turmeric.

In another embodiment, the plant-based meat-like product includes: about 5% to about 88% (e.g., about 40% to about 88%, about 45% to about 60%, or about 15% to about 55%) by weight of a meat dough; about 0% to about 40% (e.g., about 1% to about 30%, about 5% to about 25%, or about 15% to about 25%) by weight of a carbohydrate-based gel; about 5% to about 35% (e.g., about 10% to about 15%, about 12% to about 18%, or about 20% to about 25%) by weight of a fat; about 0.00001% to about 10% (e.g., about 3% to about 7%, about 0.001% to about 2%, or about 0.00001% to about 2%) by weight of a flavoring agent; about 0% to about 15% (e.g., about 2% to about 15% or about 2% to about 10%) by weight of a binding agent; and about 0.01% to about 4% (e.g., about 0.05% to about 1%, or about 0.5% to about 2%) by weight of a heme-containing protein and/or an iron salt.

In an embodiment, the plant-based meat-like product includes at least 0.00001%, at least 0.0001%, at least 0.001%, at least 0.01%, at least 0.1%, at least 1%, at least 2%, at least 3%, at least 4%, at least 5%, at least 6%, at least 7%, at least 8%, at least 9%, at least 10 or more by weight of a flavoring agent. In an embodiment, the plant-based meat-like product includes about 0.00001%, about 0.0001%, about 0.001%, about 0.01%, about 0.1%, about 1%, about 2%, about 3%, about 4%, about 5%, about 6%, about 7%, about 8%, about 9%, about 10 or more by weight of a flavoring agent. In an embodiment, the plant-based meat-like product includes no more than 0.00001%, no more than 0.0001%, no more than 0.001%, no more than 0.01%, no more than 0.1%, no more than 1%, no more than 2%, no more than 3%, no more than 4%, no more than 5%, no more than 6%, no more than 7%, no more than 8%, no more than 9%, no more than 10 or more by weight of a flavoring agent.

In a further embodiment, the plant based meat-like product includes at least 0.1%, at least 0.5%, at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least or 20% by weight of a binding agent. In a further embodiment, the plant based meat-like product includes about 0.1%, about 0.5%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about or 20% by weight of a binding agent. In a further embodiment, the plant based meat-like product includes no more than 0.1%, no more than 0.5%, no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than or 20% by weight of a binding agent.

In an embodiment, the plant-based meat-like product includes at least 0.00001%, at least 0.0001%, at least 0.001%, at least 0.01%, at least 0.1%, at least 1%, at least 2%, at least 3%, at least 4%, at least 5%, at least 6%, at least 7%, at least 8%, at least 9%, at least 10 or more by weight of a heme-containing protein and/or an iron salt. In an embodiment, the plant-based meat-like product includes about 0.00001%, about 0.0001%, about 0.001%, about 0.01%, about 0.1%, about 1%, about 2%, about 3%, about 4%, about 5%, about 6%, about 7%, about 8%, about 9%, about 10 or more by weight of a heme-containing protein and/or an iron salt. In an embodiment, the plant-based meat-like product includes no more than 0.00001%, no more than 0.0001%, no more than 0.001%, no more than 0.01%, no more than 0.1%, no more than 1%, no more than 2%, no more than 3%, no more than 4%, no more than 5%, no more than 6%, no more than 7%, no more than 8%, no more than 9%, no more than 10 or more by weight of a heme-containing protein and/or an iron salt.

In another embodiment, the plant-based meat-like product includes at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% by weight a meat dough.

In another embodiment, the plant-based meat-like product includes about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% by weight of a meat dough.

In another embodiment, the plant-based meat-like product includes no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% by weight of a meat dough.

In another embodiment, the meat-like dough containing a seaweed protein concentrate has a tensile strength that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% greater than a meat-like dough containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans and corn.

In another embodiment, the meat-like dough containing a seaweed protein concentrate has a tensile strength that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% greater than a meat-like dough containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fonio, foxtail millet, kodo millet, Japanese millet, Job's Tears), pseudograins (including, amaranth, breadnut, buckwheat, chia, cockscomb, pitseed goose opt, kaniwa, wattleseed) legumes (including, alfalfa, clover, peas, beans, lupins, mesquite, carob, soybeans, peanuts, tamarind), rice, mung beans and corn.

In another embodiment, the meat-like dough containing a seaweed protein concentrate has a tensile strength that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% greater than a meat-like dough containing a protein concentrate from another plant, including wheat, grains (including, quinoa, barley, bulgur, farro and kasha), pulse (including, lentils, dry beans, dry broad beans, dry peas, chickpeas, cow peas, pigeon peas, Bambara beans, vetches, lupins, pulses nes), cereals (including, pearl millet, proso millet, sorghum, oats, rye, teff, triticale, finger millet, fordo, foxtail millet, kodo millet, Japanese millet, Jobs Tears), pseudograins (including, amaranth, breadnut, buckwheat, chia, cockscomb, pitseed goosefoot, kaniwa, wattleseed) legumes (including, alfalfa, clover, peas, beans, lupins, mesquite, carob, soybeans, peanuts, tamarind), rice, mung beans and corn.

In another embodiment, the meat-like dough containing a seaweed protein concentrate has a color that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% the same as that of a meat from an animal.

In another embodiment, the meat-like dough containing a seaweed protein concentrate has a color that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% the same as that of a meat from an animal.

In another embodiment, the meat-like dough containing a seaweed protein concentrate has a color that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% the same as that of a meat from an animal.

In another embodiment, the plant-based meat-like product includes at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49% or at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% by weight of a carbohydrate.

In another embodiment, the plant-based meat-like product includes about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49% or about 50% by weight of a carbohydrate.

In another embodiment, the plant-based meat-like product includes no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, or no more than 50% by weight of a carbohydrate.

In another embodiment, the plant-based meat-like product includes at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44% or at least 45% by weight a fat.

In another embodiment, the plant-based meat-like product includes about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44% or about 45% by weight of a fat.

In another embodiment, the plant-based meat-like product includes no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44% or no more than 45% by weight of a fat.

In a further embodiment, a method of making a plant-based meat-like product, including a plant-based ground meat-like product can include (a) heating a plant-based meat-like product to a temperature ranging from 150.degree. F. to 250.degree. F. or to a temperature of about 150.degree. F., about 160.degree. F., about 170.degree. F., about 180.degree. F., about 190.degree. F., about 200.degree. F., about 210.degree. F., about 220.degree. F., about 230.degree. F., about 240.degree. F., about 250.degree. F., about 260.degree. F., about 270.degree. F., about 280.degree. F., about 290.degree. F., about 300.degree. F., about 310.degree. F., about 320.degree. F., about 330.degree. F., about 340.degree. F., about 350.degree. F., about 360.degree. F., about 370.degree. F., about 380.degree. F., about 390.degree. F., about 400.degree. F., about 410.degree. F., about 420.degree. F., about 430.degree. F., about 440.degree. F., about 450.degree. F., about 460.degree. F., about 470.degree. F., about 480.degree. F., about 490.degree. F. or about 500.degree. F; wherein the plant-based meat-like product includes a meat-like dough and one or more of the following a fat, the fat optionally containing a flavoring agent and/or an isolated plant protein; a carbohydrate, including a carbohydrate-based gel, an optional edible fibrous component, an optional binding agent, a heme containing protein or an iron ion and/or an iron salt, a pH adjusting agent, an antioxidant and one or more optional flavoring agents to make a plant-based meat-like product that after cooking tastes like a natural animal meat, such as a ground meat burger, wherein the meat comes from a cow.

In an embodiment, the plant-based meat-like product has a moisture content of at least about 30%. In some embodiments, the plant-based meat-like product provided herein comprise a moisture content of between about 30% and about 70%, between about 40% and about 60%, between about 33% and about 45%, between about 40% and about 50% between about 30% and about 60%, between about 50% and about 70%, or between about 55% and about 65% by weight. In another embodiment, the plant-based meat-like product has a moisture content of between about 50% and about 85%, between about 60% and about 80%, between about 50% and about 70%, between about 70% and about 80%, between about 75% and about 85%, or between about 65% and about 90% by weight.

In another embodiment, the plant-based meat-like product has a moisture content that is at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or at least 100% by weight.

In another embodiment, the plant-based meat-like product has a moisture content that is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or about 100% by weight.

In another embodiment, the plant-based meat-like product has a moisture content that is no more than 1%, no more than 2%, no more than 3%, no more than 4%, no more than 5%, no more than 6%, no more than 7%, no more than 8%, no more than 9%, no more than 10%, no more than 11%, no more than 12%, no more than 13%, no more than 14%, no more than 15%, no more than 16%, no more than 17%, no more than 18%, no more than 19%, no more than 20%, no more than 21%, no more than 22%, no more than 23%, no more than 24%, no more than 25%, no more than 26%, no more than 27%, no more than 28%, no more than 29%, no more than 30%, no more than 31%, no more than 32%, no more than 33%, no more than 34%, no more than 35%, no more than 36%, no more than 37%, no more than 38%, no more than 39%, no more than 40%, no more than 41%, no more than 42%, no more than 43%, no more than 44%, no more than 45%, no more than 46%, no more than 47%, no more than 48%, no more than 49%, no more than 50%, no more than 51%, no more than 52%, no more than 53%, no more than 54%, no more than 55%, no more than 56%, no more than 57%, no more than 58%, no more than 59%, no more than 60%, no more than 61%, no more than 62%, no more than 63%, no more than 64%, no more than 65%, no more than 66%, no more than 67%, no more than 68%, no more than 69%, no more than 70%, no more than 71%, no more than 72%, no more than 73%, no more than 74%, no more than 75%, no more than 76%, no more than 77%, no more than 78%, no more than 79%, no more than 80%, no more than 81%, no more than 82%, no more than 83%, no more than 84%, no more than 85%, no more than 86%, no more than 87%, no more than 88%, no more than 89%, no more than 90%, no more than 91%, no more than 92%, no more than 93%, no more than 94%, no more than 95%, no more than 96%, no more than 97%, no more than 98%, no more than 99% or no more than 100% by weight.

In an embodiment, a plant-based meat-like product and/or meat-like dough is made to taste, feel, have the texture and/or look of meat from an animal by adjusting the pH using a pH adjusting agent. In an embodiment, the pH is of a plant-based meat-like product and or meat-like dough is adjusted. In another embodiment, the pH of a meat-like dough is adjusted. It is known that beef has a pH of about 5.5. Therefore, in an embodiment, to make a plant-based meat-like product and/or meat-like dough to taste, feel, have the texture and/or color of beef, the pH of the plant-based meat-like product and/or meat-like dough can be made to be about 5.5. A pH adjusting agent may be organic or inorganic. In one embodiment, a pH adjusting agent includes a salt, an ionic salt, an alkali metal, an alkaline earth metal, a monovalent or divalent cationic metals, hydroxides, carbonates, bicarbonates, chlorides, gluconates, acetates, sulfides, monovalent or divalent cationic metals (e.g. calcium, sodium, potassium, and magnesium). In a further embodiment, an acidic pH adjusting agents include acetic acid, hydrochloric acid, citric acid, succinic acid, and combinations thereof. In another embodiment, a basic pH adjusting agents include potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. In one embodiment, a pH adjusting agent is a food grade edible acid or food grade edible base. In an embodiment, lactic acid is used as the pH adjusting agent. Lactic acid is known to provide a fresh taste that includes a sourness that is associated with in beef.

Other pH adjusting agents can be used depending on the desired flavor, texture, color and feel of the plant-based meat-like product and/or meat-like dough. A pH adjusting agent can be used to bring the pH of the plant-based meat-like product and/or meat-like dough to about 1, about 2, about 3, about 4, about 5, about 6, about 7, about 8, about 9, about 10, about 11, about 12 and or about 13. In another embodiment, a pH adjusting agent can bring the pH of the plant-based meat-like product and/or meat-like dough to have a pH of between 7.2 and about 12, between 7.2 and about 10, between 7.4 and about 10.0, between 7.6 and about 9.0, between 7.8 and about 9.0, between about 8.0 and about 9.0, or between about 8 and about 10. In a further embodiment the pH of the pH adjusting agents is lower than 7, between 6.95 and about 2, between 6.95 and about 4, between about 4 and about 2, higher than 7.05, between 7.05 and about 12, between 7.05 and about 10, between 7.05 and about 8, between about 9 and about 12, or between about 10 and about 12.

In an embodiment, the plant-based meat-like product can be shaped into patties like those commonly associated with a hamburger. A patty can have any shape, including a square, a rectangular, a circle, and/or any non-geometric shape. In one embodiment, the patties are circular and have diameters of about 10 mm, 20 mm, 30 mm, 40 mm, 50 mm, 60 mm, 70 mm, 80 mm, 90 mm, 100 mm, 110 mm, 120 mm, 130 mm, 140 mm, 150 mm or larger. In one embodiment, the patties are circular and have diameters of at least 10 mm, 20 mm, 30 mm, 40 mm, 50 mm, 60 mm, 70 mm, 80 mm, 90 mm, 100 mm, 110 mm, 120 mm, 130 mm, 140 mm, 150 mm or larger. In one embodiment, the patties are circular and have diameters of no more than 10 mm, 20 mm, 30 mm, 40 mm, 50 mm, 60 mm, 70 mm, 80 mm, 90 mm, 100 mm, 110 mm, 120 mm, 130 mm, 140 mm, 150 mm or larger.

In another embodiment, a plant-based meat-like product may be packaged to keep them clean, fresh, contained and/or safe. In another embodiment, the packaging is meant to allow for inventory control, handling, distribution, stacking, display, sale, opening, reclosing, use, or reuse and/or to enable control of portion size. Suitable packing includes trays, trays with overwrap, bags, cups, films, jars, tubs, bottles, pads, bowls, platters, boxes, cans, cartons, pallets, wrappers, containers, bags-in-boxes, tubes, capsules, vacuum packaging, pouches, and the like, and combinations thereof. The packaging can be made of plastic, paper, metal, glass, paperboard, polypropylene, PET, styrofoam, aluminum, or combinations thereof.

In an embodiment, the packaging may carry one or more labels that communicate information to the consumer or that support the marketing of the plant-based meat-like product. In a further embodiment, the packaging carries a label required by federal, state or a local governmental regulation. In one embodiment, the label is required by regulation of the U.S. Food and Drug Administration (FDA) or the U.S. Department of Agriculture (USDA). In another embodiment, the label is required by regulation of the European Food Safety Authority. In a further embodiment, the governmental regulation is Title 21 of the FDA section of the code of federal regulations. In another embodiment, the label indicates that the enclosed meat structured protein product is free of genetically modified organisms. In another embodiment, the label indicates that the enclosed plant-based meat-like product is free of gluten. In one more embodiment, the label indicates that the enclosed plant-based meat-like product is Kosher. In another embodiment, the label indicates that the enclosed plant-based meat-like product is free of cholesterol. In another embodiment, the label indicates that the plant-based meat-like product is vegan. In a further embodiment, the label indicates that the plant-based meat-like product is free of an allergen. In another embodiment, the label indicates that the plant-based meat-like product is free of soy. In one more embodiment, the label indicates that the plant-based meat-like product is free of nuts.

### EXAMPLES

### Example 1: Color and Color Change

Sample preparation: Samples were prepared by combining seaweed protein concentrate, commercial textured vegetable protein (Anthony's TVP, CA, USA), methylcellulose (Pure Methylcellulose High Viscosity, Modernist Pantry, Eliot, Me., USA), high oleic safflower oil (Pompeian, CA, USA), and refined coconut oil that had been frozen in a thin layer and crushed into chips (La Tourangelle, Calif., USA) (Table 1). Protein was concentrated from the red seaweeds, Gracilaria and Porphyra, to generate a protein concentrate of 62.0% and 63.2% protein on a dry basis, respectively. The seaweed protein concentrates were added as a wet paste and added to achieve 0.125 g of total dry solids each. The safflower oil and methylcelluose were mixed together in a ratio of 75% to 25%, respectively before adding as a slurry to the rest of the ingredients. All ingredients were mixed and allowed to hydrate for 20 min at room temperature. The samples were then formed into small patties and frozen at −20 C.

TABLE 1
Ingredients for samples used in color change analysis.
Meat like dough patties were comprised of textured
vegetable protein (TVP, soy), seaweed protein concentrate,
filtered water, high oleic safflower oil (HOSO),
methylcellulose (MC), and coconut oil (CO).

| | | Seaweed | | HOSO/ | | |
|---|---|---|---|---|---|---|
| | | protein | | MC | | |
| | | concentrate | | Slurry | CO | Total |
| | TVP (g) | paste (g) | Water (g) | (g) | (g) | (g) |
| Gracilaria | 1.5 | 1.1 | 5.60 | 0.8 | 1.0 | 10 |
| Porphyra | 1.5 | 1.4 | 5.30 | 0.8 | 1.0 | 10 |

Color analysis: The color of the dough-like patty was determined using a Spectro 1 colorimeter (Variable Inc., Chattanooga Tenn., USA) using illuminant D65. A reference tile was used for calibration, and the results were expressed using the CIELAB system (determining L*—lightness, a*—(green/red), and b*—(blue/yellow)). Four readings for each L*a*b* value were collected and averaged, and data were collected at two time points; immediately after the dough-like patties were removed from the freezer, and 5 minutes after the patties were cooked at medium heat for 3 minutes on each side (Table 2).

TABLE 2
L* a* b* color values taken before and after cooking
to demonstrate color change in response to typical
cooking methods. The data are an average of four
readings +/− the standard deviation.

| | Pre-cooking | | | Post-cooking | | |
|---|---|---|---|---|---|---|
| Protein type | L* | a* | b* | L* | a* | b* |
| Gracilaria | 44.2 ± 0.7 | 11.4 ± 0.6 | 0.4 ± 0.1 | 38.2 ± 1.1 | 7.1 ± 1.2 | 6.4 ± 1 |
| Porphyra | 41.8 ± 2.2 | 6.9 ± 0.5 | 3.8 ± 0.6 | 36 ± 3.4 | 4.7 ± 1.5 | 7.4 ± 1.2 |

The dough-like patties containing seaweed protein concentrated from Gracilaria or Porphyra started with a red/pink color prior to cooking. Post-cooking these samples were a light brown color as demonstrated by the L*a*b* values.

### Example 2: Water Holding Capacity

Water holding capacity analysis: Commercial samples tested included commercial textured vegetable protein (Anthony's TVP, CA; USA, 50% protein) and soy protein isolate, (SPI: Bob's Red Mill, CA, USA, 90% protein). For the commercial samples that were purchased as a dry powder, each test was initiated with 10 g of dry initial material. 10 g of filtered water was added to the material, mixed, and allowed to absorb for 5 minutes. 10 g of water continued to be added until the material no longer absorbed additional water after the 5 minutes waiting period. Once the material reached water holding capacity, the material was filtered through a porous cloth and any unabsorbed (i.e., excess water) weighed. The water holding capacity was calculated as the total water added to the material minus the excess water removed in the final step. Water holding capacity is displayed as a ratio of initial weight to water absorbed (Table 3). For the Gracilaria and Porphyra samples, the protein was extracted as a wet paste, and the water holding capacity calculated as the amount of water that remained in the protein sample after the protein had been centrifuged at 3500 rpm for 5 minutes and any unabsorbed water decanted. Water absorbed is calculated as the grams of water present in 10 grams of dry solids to allow for comparison with the commercial samples (Table 3).

TABLE 3
Water holding capacity calculated for textured vegetable protein
(TVP, soy, 50% protein), soy protein isolate (SPI; 90% protein), seaweed
protein concentrates from Gracilaria (62.0% protein) and Porphyra
(63.3% protein), and dried powdered whole Porphyra (23.5% protein).

| | | | Water |
|---|---|---|---|
| | | Water | holding |
| | | absorbed | capacity |
| Protein type | Sample type | (g) | (%) |
| TVP | Textured Vegetable Protein | 32.2 | 322 |
| SPI | Soy protein isolate | 48.25 | 482.5 |
| Gracilaria | Protein concentrate | 88.5 | 885 |
| Porphyra | Protein concentrate | 107.3 | 1073 |
| Porphyra | Dried powdered seaweed | 122.5 | 1225 |

The Gracilaria and Porphyra protein concentrates demonstrated water holding capacities that were approximately two to three times that of the two soy samples tested. It was not possible to dry the Gracilaria and Porphyra protein concentrates using a method that would be comparable to commercially dried samples, therefore a different methodology was utilized to measure water holding capacity. Whole Porphyra that had been commercial dried was powdered and tested using the same methods as for the TVP and soy. The water holding capacity of seaweed dried at commercial scale was comparable to the values for the Gracilaria and Porphyra protein concentrates using the second method.

### Example 3: B12

B12 analysis: Samples were generated and submitted for external analytical testing of B12 at Eurofins Food Chemistry Testing (Madison, Wis., USA) using the microbiological method. In brief, the microbiological method relies on the specific requirement for vitamin B12 by certain bacterial organisms (e.g., Lactobacillus delbreueckii) to enable their growth in a supporting medium. Under appropriate conditions, the amount of growth obtained is proportional to the amount of vitamin B12 in the test extract (Table 4).

TABLE 4
B12 concentration in whole dried seaweed and seaweed protein
concentrate (dry basis).

| B12 | Whole dried seaweed | Protein concentrate |
|---|---|---|
| concentration | (mcg/g) | (mcg/g; dry basis) |
| Gracilaria | 0.149 | 0.257 |
| Porphyra | 0.663 | 0.726 |

Both Gracilaria and Porphyra contain B12, and the concentration was increased in the protein concentrate in both following the test. The daily recommended dose for adults of B12 is 2.4 mcg/day, approximately 9.3 grams of Gracilaria protein concentrate, or 3.3 grams of Porphyra protein concentrate.

### Example 4: Foaming

Foaming method: The method was modified from Aluko et al. (2009), “Emulsifying and Foaming Properties of Commercial Yellow Pea (Pisum sativum L.) Seed Flours”, J. Agric. Food Chem. Vol 57: 9793-9800. Samples tested were soy protein isolate (SPI; Bob's Red Mill, CA; USA; 90% protein), pea protein isolate (PPI: Anthony's Premium Pea Protein, CA; USA, 80% protein), and protein concentrates generated by Trophic from Gracilaria (62.0% protein, dry basis) and Porphyra (63.3% protein; dry basis). For each sample, 1.25 g of each material was raised to a final volume of 50 mls with filtered water. The SPI and PPI were added as a dry powder, while the seaweed protein concentrate was added as a paste calculated to contain 1.25 g of dry solids. The pH of the 50 mls of solution was adjusted to 7.0 using 1N NaOH. The liquid was foamed using a handheld frother for 30 seconds. The foamed liquid was poured into a 100 ml graduated cylinder, and the initial volume of foam measured in milliliters (mis; foam capacity). After 30 min, the remaining foam was measured in milliliters (mis; foam stability). Two replicates were conducted for each test and the results are displayed as averages+/−the standard deviation (n=2).

TABLE 5
Foaming capacity and stability of commercial soy protein isolate
(SPI), pea protein isolate (PPI), Gracilaria concentrate, and
Porphyra concentrate (n = 2).

| | Foam capacity | Foam stability | % |
|---|---|---|---|
| Sample | (mls) | (mls) | decrease |
| SPI | 2.5 ± 0.7 | 2 ± 0 | 20.0 |
| PPI | 80 ± 2.8 | 7 ± 2.8 | 91.3 |
| Gracilaria | 71.5 ± 2.1 | 34 ± 2.8 | 52.4 |
| Porphyra | 78 ± 1.4 | 43 ± 4.2 | 44.9 |

The Gracilaria and Porphyra both demonstrated high foam capacity and stability, where they only lost approximately 50% of the initial foam over 30 min. This was in contrast to the soy protein isolate (SPI) that demonstrated a very low foaming capacity. The pea protein isolate (PPI; 80% protein) had a foaming capacity slightly greater than the seaweed protein concentrates, however, over 30 min, nearly all of the foam in the PPI dissipated.

### Example 5: Texture Profile Analysis

Sample preparation: Samples were generated using a mix of commercial textured vegetable protein (Anthony's TVP. CA, USA, 50% protein), soy protein isolate (Bob's Red Mill, CA, USA, 90% protein), methylcellulose (Pure Methylcellulose High Viscosity (Modernist Pantry, Eliot, Me., USA), high oleic safflower oil (Pompeian, CA, USA), and refined coconut oil that had been frozen in a thin layer and crushed into chips (La Tourangelle, Calif., USA) (Table 6). Porphyra samples were generated by grinding and desalting commercial dried Porphyra (Sinzau Laver, Sin Zau Enterprise Co, Taiwan), followed by drying. Post-drying, the Porphyra contained 23.4% protein. The safflower oil and methylcellulose were mixed together to form a slurry before adding to the rest of the ingredients. All remaining ingredients were mixed and allowed to hydrate for 20 min at room temperature. The final dough-like material was kneaded by hand and separated into three 20 g portions. The portions were shaped into spheres by hand and placed in the freezer until analysis. Prior to analysis, the samples were warmed to 4° C. in a refrigerator and then to room temperature in a cool water bath (20° C.).

TABLE 6
Ingredients for the samples used in texture analysis.

| | | | Protein | | | |
|---|---|---|---|---|---|---|
| | | | (SPI or | | Methyl- | Coconut |
| | TVP | Water | Porphyra) | Safflower | cellulose | oil |
| Sample | (g) | (g) | (g) | oil (g) | (g) | (g) |
| SPI 1 | 12 | 49.6 | 4 | 4.8 | 0.8 | 8 |
| SPI 2 | 12 | 49.6 | 4 | 4.8 | 1.6 | 8 |
| Porphyra 1 | 12 | 49.6 | 4 | 4.8 | 0 | 8 |
| Porphyra 2 | 12 | 49.6 | 4 | 4.8 | 1.6 | 8 |

### Example 6: Texture Analysis

Texture analysis: TPA was conducted using a TA.XT Pius Connect Texture Analyzer (Texture Technologies Corp.; Hamilton, Mass., USA) with a TA-40A polymethylmethacrylate cylinder probe of 101.6 mm diameter and 10 mm height (Texture Technologies Corp., Hamilton, Mass.; USA). The cylinder probe compressed each sample using a trigger force of 3 g to 50% compression in a 2-cycle analysis at a test speed of 0.5 mm/sec. A deformation curve of each sample was obtained, and the values for Force1, Force2, Area FT1:2, Time-diff 1:2, AreaFT1:3, AreaFT2:3, AreaFT4:6, and Time-diff4:5 were calculated according to the manufacturer's software and the individual TPA parameters were calculated by the software as follows: Springiness=(Time-diff4:5/Time-diff1:2); Cohesiveness=(AreaFT4:6/AreaFT1:3); Hardness=Force I; Gumminess=(Hardness×Cohesiveness); Chewiness=(Springiness×Gumminess); and Resilience=(Area FT2:3/Area FT1:2).

This is further described in Food Texture and Viscosity Second Edition: Concept and Measurement, Dr. Malcolm C. Bourne, April 2002, Academic Press, New York. Average measurements were obtained from the analysis of 3 independent samples, the results of which are shown in Table 7.

TABLE 7
Texture analysis data comparing the impact of soy protein versus Porphyra on texture.

| Sample | MC % | Hardness | Springiness | Cohesiveness | Gumminess | Chewiness | Resilience |
|---|---|---|---|---|---|---|---|
| SPI 2 | 1 | 129.4 ± 18.2 | 0.25 ± 0.09 | 0.23 ± 0.05 | 29.5 ± 10 | 7.8 ± 5.6 | 0.034 ± 0.003 |
| SPI 1 | 2 | 161.3 ± 25.2 | 0.21 ± 0.02 | 0.23 ± 0.03 | 36.8 ± 8.7 | 7.7 ± 2.3 | 0.032 ± 0.002 |
| Porphyra 1 | 0 | 273.4 ± 20.4 | 0.16 ± 0.02 | 0.16 ± 0.02 | 42.1 ± 2.7 | 6.9 ± 1.1 | 0.026 ± 0.001 |
| Porphyra 2 | 2 | 389.1 ± 41.4 | 0.22 ± 0.04 | 0.19 ± 0.03 | 75 ± 21 | 17 ± 7.7 | 0.041 ± 0.011 |

The Porphyra samples demonstrated increased hardness compared to the soy protein isolate samples, even when no methylcellulose was added. The gumminess was also increased, and more than doubled when Porphyra was combined with methylcellulose. The combination of Porphyra and methylcellulose results in a material that has a greater hardness, gumminess, and chewiness compared to soy protein isolate samples.

A plant-based meat-like product comprising of about 1% to about 90% of a seaweed protein concentrate, about 1% to about 90% of a non-seaweed protein isolate or concentrate, about 0% to about 30% of carbohydrate, and about 1% to 30% lipid.

The plant-based meat-like product of claim 1, wherein the seaweed protein concentrate contains 35-90% protein.

The plant-based meat-like product of claim 1, wherein the protein fraction of the seaweed protein concentrate is at least 25% phycoerythrin.

The plant-based meat-like product of claim 1, wherein the polyphenol content is from about 0.1% to 10%.

The plant-based meat-like product of claim 1, wherein the plant-based meat-like product contains an animal protein.

The plant-based meat-like product of claim 1, wherein the seaweed protein is derived and/or obtained from a red seaweed (Rhodophyta).

The plant-based meat-like product of claim 6, where the red seaweed is one or more of Gracilaria, Porphyra, Pyropia, Kappaphycus, Eucheuma, and Palmaria.

The plant-based meat-like product of claim 1, wherein the seaweed protein is derived from a brown seaweed (Phaeophyta).

The plant-based meat-like product of claim 8, where the brown seaweed is one or more of Undaria, Alaria, Laminaria, Sargassum, and Saccharine.

The plant-based meat-like product of claim 1, wherein the seaweed protein is derived from a green seaweed (Chlorophyta).

The plant-based meat-like product of claim 10, wherein the green seaweed is Ulva.

The plant-based meat-like product of claim 1, wherein the plant-based meat-like product is to replace a meat product.

The plant-based meat-like product of claim 12, wherein the meat to be replaced is from a cow, a goat, a sheep, a pig or a bird.

The plant-based meat-like product of claim 1, wherein the plant-based meat-like product is to replace a seafood.

The plant-based meat-like product of claim 14, wherein the seafood to be replaced is from a fish, a shrimp, a lobster, a scallop, a crab, a squid, an octopus or an eel.

The plant-based meat-like product of claim 1, wherein the plant-based meat-like product is to replace a cheese.

The plant-based meat-like product of claim 16, wherein the cheese to be replaced is from a cow, a goat or a sheep.

The plant-based meat-like product of claim 1, wherein the plant-based meat-like product is to replace an egg.

The plant-based meat-like product of claim 18, wherein the egg to be replaced is from a chicken, a turkey, a duck, or an ostrich.

The plant-based meat-like product of claim 1, wherein the plant-based meat-like product is to replace milk.

The plant-based meat-like product of claim 20, wherein the milk to be replaced is from a cow, a goat or a sheep.

The plant-based meat-like product of claim 1, wherein the plant-based meat-like product changes color upon heating.

The plant-based meat-like product of claim 22, wherein the color change upon heating is a change in color from a pinkish, reddish, or reddish-purple like color to a brownish color.

The plant-based meat like product of claim 23, wherein the color change is only on the outside.

The plant-based meat-like product of claim 24, wherein the inside of the plant-based meat-like product remains a pinkish, reddish or reddish-purple like color.

The plant-based meat-like product of claim 23, wherein the color change upon heating is a change in color to a brownish color on the outside and most or all of the inside of the plant-based meat-like product.

The plant-based meat-like product of claim 22, wherein the plant-based meat-like product is in the shape of a burger.

The plant-based meat-like product of claim 22, wherein the plant-based meat-like product is in the shape of a sausage.

The plant-based meat-like product of claim 22, wherein the plant-based meat-like product is in the shape of a beef steak.

A protein concentration for use in a plant-based meat-like product, wherein the protein concentrate is a seaweed protein concentrate.

The protein concentrate of claim 30, wherein the seaweed protein concentrate contains 35-90% protein.

The protein concentrate of claim 30, wherein the protein fraction of the seaweed protein concentrate is at least 25% phycoerythrin.

The protein concentrate of claim 30, wherein the polyphenol content is from about 0.1% to 10%.

The protein concentrate of claim 30, wherein the seaweed protein is derived and/or obtained from a red seaweed (Rhodophyta).

The protein concentrate of claim 30, where the red seaweed is one or more of Gracilaria, Porphyra, Pyropia, Kappaphycus, Eucheuma, and Palmaria.

The protein concentrate of claim 30, wherein the seaweed protein is derived from a brown seaweed (Phaeophyta).

The protein concentrate of claim 30, where the brown seaweed is one or more of Undaria, Alaria, Laminaria, Sargassum, and Saccharina.

The protein concentrate of claim 30, wherein the seaweed protein is derived from a green seaweed (Chlorophyta).

The protein concentrate of claim 30, wherein the green seaweed is Ulva.

The above non-limiting examples are provided for illustrative purposes only in order to facilitate a more complete understanding of the disclosed subject matter. These examples should not be construed to limit any of the embodiments described in the present specification, including those pertaining to the antibodies, pharmaceutical compositions, or methods and uses for treating cancer, a neurodegenerative or an infectious disease.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the following appended claims and claims hereafter introduced are interpreted to include all such changes, modifications, permutations, alterations, additions, subtractions and sub-combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. For instance, as mass spectrometry instruments can vary slightly in determining the mass of a given analyte, the term “about” in the context of the mass of an ion or the mass/charge ratio of an ion refers to +/−0.50 atomic mass unit. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter. Further, the use of the terms “include,” “includes” and “including” means include, includes and or including as well as include, includes and including, but not limited to.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (and equivalent open-ended transitional phrases thereof like including, containing and having) encompasses all the expressly recited elements, limitations, steps and/or features alone or in combination with unrecited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amended for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Lastly, the terminology used herein is for the purpose of describing particular embodiments only and is not intended to limit the scope of the present invention, which is defined solely by the claims. Accordingly, the present invention is not limited to that precisely as shown and described.

1. A method of making a plant-based meat-like dough comprising:
(a) providing red seaweed source material comprising a protein fraction which includes phycoerythrin and a non-protein fraction;
(b) purifying the red seaweed source material to form a purified protein isolate wherein the protein fraction comprises at least about 60%, by dry weight, of the purified protein isolate; and
(c) combining the purified protein isolate with textured vegetable protein, water, a binding agent and an oil to form the meat-like dough.

2. The method of claim 1 wherein the protein fraction comprises vitamin B12 in a higher concentration than is present in the red seaweed source material.

3. The method of claim 1 wherein the protein fraction comprises at least 25%, by dry weight, phycoerythrin.

4. The method of claim 1 wherein the non-protein fraction comprises at least one of agar, carrageenan and porphyran.

5. The method of claim 1 wherein the oil comprises sunflower oil and/or coconut oil.

6. The method of claim 1 wherein the protein fraction comprises about 60% to about 80%, by dry weight, of the purified protein isolate.

7. The method of claim 1 wherein the binding agent is a carbohydrate.

8. The method of claim 7 wherein the carbohydrate comprises methylcellulose or a starch.

9. The method of claim 1 further comprising combining a flavoring agent with the purified protein isolate or the meat-like dough.

10. The method of claim 1 wherein the purified protein isolate is in powder or liquid form.

11. The method of claim 1 wherein the purified protein isolate is water soluble.
